(19) United States
(12) Patent Application Publication
(10) Pub. No.: US 2022/0212902 A1
(43) Pub. Date: Jul. 7, 2022

(54) NOVEL LOWER-TROLLEY SYSTEM

(71) Applicant: HUADIAN LANCO TECHNOLOGIES CO., LTD., Beijing (CN)

(72) Inventors: QIANG XIAO, Beijing (CN); SHUWANG GUO, Beijing (CN); YINGJIU ZHAO, Beijing (CN); XUEFENG ZHENG, Beijing (CN)

(21) Appl. No.: 17/594,910

(22) PCT Filed: Jul. 12, 2019
(86) PCT No.: PCT/CN2019/095670

§ 371 Date: Nov. 3, 2021

(30) Foreign Application Priority Data
May 4, 2019 (CN) 201910377358.9

(51) Int. Cl. B66C 19/00; B66C 11/04

(52) U.S. Cl. CPC B66C 19/002; B66C 11/04

(57) ABSTRACT

The invention is a novel lower-trolley system, comprising a lower trolley (3), a lower-trolley hoisting system, and a lower-trolley travelling system. The lower trolley (3), the lower-trolley hoisting system and the lower-trolley travelling system are all arranged on a quay crane; the lower-trolley hoisting system drives a hoist (14) of the lower trolley (3) to rise and fall, and the lower-trolley travelling system pulls the lower trolley (3) to make same travel in the direction of a double-trapezoid four-track girder (1) of the quay crane; and the lower trolley (3) is hung upside down on outer-side tracks (15) of the double-trapezoid four-track girder (1), and a container (12) hoisted by an upper trolley (2) can pass through the lower trolley (3).

### CROSS-REFERENCE TO RELATED APPLICATIONS

This application is a 371 of International Patent Application Number PCT/CN2019/095670, filed on Jul. 12, 2019, which claims the benefit and priority of Chinese Patent Application Number 201910377358.9, filed on May 4, 2019 with China National Intellectual Property Administration, the disclosures of which are incorporated herein by reference in their entireties.

### TECHNICAL FIELD

The present disclosure relates to the technical field of novel efficient container loading and unloading equipment, in particular to, a novel lower-trolley system.

### BACKGROUND

At present, a conventional quay crane having a single trolley has been mostly applied at home and abroad, and containers are loaded and unloaded by adopting the single trolley, in such a way, the loading and unloading efficiency of the single quay crane reaches the limit, but the demand of a wharf for the loading and unloading efficiency still cannot be met. For a large container ship, a manner of increasing the number of operations of the quay crane is almost adopted to increase the every-hour loading and unloading efficiency of the ship, but demands of clients for the every-hour loading and unloading efficiency of the ship cannot be met by simply increasing the number of the operations of the quay crane due to an operation interval of the quay crane. If the conventional quay crane having the single trolley is directly abandoned and replaced with a more advanced quay crane system that is newly established, people will face huge investment cost and great waste of available resources. Therefore, in order to reduce the investment cost and increase the loading and unloading efficiency of the conventional quay crane, people have to break through conventional thinking to upgrade the conventional quay crane into a structure having an upper trolley and a lower trolley, at the moment, a novel lower-trolley system matched with the quay crane urgently needs to be designed.

### SUMMARY

The objective of the present disclosure is to provide a novel lower-trolley system which improves on the conventional quay crane having a single operation trolley by adding one more lower trolley, a lower-trolley hoisting system, and a lower-trolley travelling system on an outer side of an original quay crane girder and upgrading the quay crane girder, such that the two trolleys of the quay crane have enough space to pass by each other and operate at the same time, thereby doubling loading and unloading efficiency.

In order to solve the above-mentioned technical problem, the present disclosure adopts the following technical solutions:

provided is a novel lower-trolley system in which a conventional quay crane girder is upgraded into a double-trapezoid four-track girder, and inner-side tracks of the double-trapezoid four-track girder are configured for an upper trolley to travel on. The novel lower-trolley system includes a lower trolley, a lower-trolley hoisting system, and a lower-trolley travelling system, and the lower trolley, the lower-trolley hoisting system and the lower-trolley travelling system are all arranged on a quay crane; the lower-trolley hoisting system is configured to drive a hoist of the lower trolley to rise and fall, and the lower-trolley travelling system is configured to pull the lower trolley to travel along the direction of the double-trapezoid four-track girder of the quay crane; and the lower trolley is suspended upside down on outer-side tracks of the double-trapezoid four-track girder, and a container hoisted by the upper trolley is able to pass through the lower trolley. The novel lower-trolley system is used for upgrading a conventional quay crane, outer sides of two original box beams are each additionally provided with two plates to form the double-trapezoid four-track girder, and the outer side of the double-trapezoid four-track girder is additionally provided with track bearing beams and is laid with the outer-side tracks to bear the newly added lower trolley which is suspended upside down. Specifically, the novel lower-trolley system is designed, so that the hoist of the lower trolley can rise and fall, and the lower trolley can travel. The space structure for the lower trolley is cleverly arranged, such that the upper trolley and the lower trolley of the upgraded quay crane have enough space to pass by each other without interfering with each other, and the quay crane is upgraded from one trolley to two trolleys to operate, so that the operation efficiency of the quay crane is greatly increased.

For the aforementioned novel lower-trolley system, the lower-trolley hoisting system includes a lower-trolley hoisting mechanism and a lower-trolley hoisting winding system, and the lower-trolley hoisting mechanism is configured to drive the hoist of the lower trolley to rise and fall through the lower-trolley hoisting winding system. The lower-trolley hoisting mechanism is arranged in a quay crane machine room, the lower-trolley hoisting mechanism includes a lower-trolley hoisting mechanism part-A, a lower-trolley hoisting mechanism part-B and a floating coupling, the lower-trolley hoisting mechanism part-A is connected to the lower-trolley hoisting mechanism part-B via the floating coupling, wherein the floating coupling is horizontally arranged behind an upper-trolley hoisting mechanism, and the lower-trolley hoisting mechanism part-A and the lower-trolley hoisting mechanism part-B are respectively arranged on left and right sides of the upper-trolley hoisting mechanism. The lower-trolley hoisting winding system includes a lower-trolley hoisting winding group-A and a lower-trolley hoisting winding group-B, the lower-trolley hoisting mechanism part-A drives the hoist of the lower trolley to rise and fall through the lower-trolley hoisting winding group-A, and meanwhile, the lower-trolley hoisting mechanism part-B is configured to drive the hoist of the lower trolley to rise and fall through the lower-trolley hoisting winding group-B. Due to the arrangement of the floating coupling, it can be ensured that the lower-trolley hoisting mechanism part-A and the lower-trolley hoisting mechanism part-B operate synchronously, and the problem that the hoist of the lower trolley tilts due to operation asynchronism of the two mechanisms is avoided, which is a great innovation for the lower-trolley hoisting mechanism. In addition, the quay crane machine room is limited in space, in order to place the newly added lower-trolley hoisting mechanism part-A and lower-trolley hoisting mechanism part-B without newly building a machine room or reducing the upgrading cost, the floating coupling plays a good linking role, and the floating coupling is set to be small-sized and is respectively connected with the lower-trolley hoisting mechanism part-A and the lower-trolley hoisting mechanism part-B on the left and the right, so that the remaining space of the original quay crane machine room is sufficiently utilized, the utility rate of the space is increased, and the stable operation of the newly added lower trolley can also be guaranteed. Specifically, the lower-trolley hoisting mechanism part-A includes a hoist drum-A, a motor-A, and a speed reducer-A, wherein one side of the motor-A is coaxially connected with the speed reducer-A, and the other side of the motor-A is connected with the hoist drum-A by a shaft; and the lower-trolley hoisting mechanism part-B includes a hoist drum-B, a motor-B, and a speed reducer-B, wherein one side of the motor-B is coaxially connected with the speed reducer-B, and the other side of the motor-B is connected with the hoist drum-B by a shaft.

For the aforementioned novel lower-trolley system, the lower trolley includes a recessed frame, a movable trolley and wheels, wherein the wheels are arranged on two sides of the top of the recessed frame and are configured to roll on the outer-side tracks of the double-trapezoid four-track girder, the movable trolley is arranged on the bottom of the recessed frame, and the hoist is connected below the movable trolley. The lower trolley is provided with the recessed frame which forms a recessed self-closed space in space, and such a space is large enough to allow the container hoisted by the upper trolley to pass by without interference. Compared with a U-shaped frame of a lower trolley of a novel quay crane, the present structure allows the upper trolley to pass through the recessed space of the lower trolley without changing the position of the double-trapezoid four-track girder, thereby reducing the investment. The movable trolley is used for bearing the hoist and is capable of moving on the recessed frame.

For the aforementioned novel lower-trolley system, a movable trolley track is laid on the bottom of the recessed frame, the movable trolley includes a trolley body and travelling wheels, and the travelling wheels are mounted on two sides of the bottom of the trolley body and are configured to roll on the movable trolley track.

For the aforementioned novel lower-trolley system, the recessed frame includes a horizontal frame, a first vertical frame group, and a second vertical frame group, wherein one end of the horizontal frame is connected with an end of the first vertical frame group, the other end of the horizontal frame is connected with an end of the second vertical frame group, and structures of the first vertical frame group and the second vertical frame group are symmetrically disposed relative to the middle of the horizontal frame. The first vertical frame group includes a first vertical rod and a second vertical rod; the second vertical frame group further includes a first vertical rod and a second vertical rod; and the wheels are arranged on top ends of the first vertical rods, the other ends of the first vertical rods are connected with ends of the second vertical rods, and the other ends, away from the first vertical rods, of the second vertical rods are connected with the horizontal frame. In such a layout way, the upper trolley and the lower trolley can pass by each other without changing a girder spacing of the conventional quay crane on the premise that the upgrading cost is relatively low, and interference can also be avoided.

The aforementioned novel lower-trolley system further includes a first redirecting pulley block, a second redirecting pulley block, a third redirecting pulley block, a fourth redirecting pulley block, a fifth redirecting pulley block, a sixth redirecting pulley block, a seventh redirecting pulley block, and an eighth redirecting pulley block, wherein the first redirecting pulley block is mounted on the top of the first vertical rod of the first vertical frame group, the second redirecting pulley block is mounted on an intersection of the first vertical rod of the first vertical frame group and the second vertical rod of the first vertical frame group, the horizontal frame is sequentially provided with the third redirecting pulley block, the fourth redirecting pulley block, the fifth redirecting pulley block, and the sixth redirecting pulley block from left to right, the seventh redirecting pulley block is mounted on an intersection of the first vertical rod of the second vertical frame group and the second vertical rod of the second vertical frame group, and the eighth redirecting pulley block is mounted on the top of the first vertical rod of the second vertical frame group.

For the aforementioned novel lower-trolley system, the lower-trolley hoisting winding group-A includes a first quay crane redirecting pulley block mounted on the quay crane, further includes the first redirecting pulley block, the second redirecting pulley block, the third redirecting pulley block, and the fourth redirecting pulley block, further includes a hoist pulley-A mounted on the hoist of the lower trolley, and further includes a quay crane pulley-A mounted on the double-trapezoid four-track girder of the quay crane. The lower-trolley hoisting winding group-B includes a hoist rope, further includes a second quay crane redirecting pulley block mounted on the quay crane, further includes the fifth redirecting pulley block, the sixth redirecting pulley block, the seventh redirecting pulley block, and the eighth redirecting pulley block, further includes a hoist pulley-B mounted on the hoist of the lower trolley, and further includes a quay crane pulley-B mounted on the double-trapezoid four-track girder of the quay crane. One end of the hoist rope is wound on the lower-trolley hoisting mechanism part-B, and the other end of the hoist rope, after firstly being wound through a lower side of the second quay crane redirecting pulley block and then being wound through the eighth redirecting pulley block, the seventh redirecting pulley block, the sixth redirecting pulley block, the fifth redirecting pulley block, and the hoist pulley-B, is wound on the quay crane pulley-B, and, after being wound through the quay crane pulley-A and then being wound through the first redirecting pulley block, the second redirecting pulley block, the third redirecting pulley block, the fourth redirecting pulley block, and the hoist pulley-A, is wound on the first quay crane redirecting pulley block, and is finally wound on the lower-trolley hoisting mechanism part-A. According to the present disclosure, due to the special structural design for the lower-trolley hoisting mechanism and the lower-trolley hoisting winding system, the lower-trolley hoisting mechanism and the lower-trolley hoisting winding system are effectively staggered from the upper-trolley hoisting mechanism and the upper-trolley hoisting winding system without interfering with each other.

For the aforementioned novel lower-trolley system, an included angle between each of the first vertical rods and a vertical central line of a corresponding one of the outer-side tracks is an acute angle, an included angle between each of the first vertical rods and a corresponding one of the second vertical rods is a blunt angle, and an included angle between each of the second vertical rods and the horizontal frame is an acute angle or a right angle. In such a layout way, the bearing capacity of the recessed frame can be better achieved, and the stability in an operation process is higher.

For the aforementioned novel lower-trolley system, horizontal guide wheel groups are further mounted on the top of the recessed frame and are arranged on outer sides of the wheels; and each of the horizontal guide wheel groups includes a horizontal wheel and a rotation shaft, and the horizontal wheel is coaxially sleeved on the rotation shaft and is able to rotate around the rotation shaft. The horizontal guide wheel group can prevent the wheels of the lower trolley from deviating and also reduce the abrasion of the outer-side tracks. Specifically, when the lower trolley laterally deviates, the horizontal guide wheel group may abut against the outer sides of the wheels to correct the lateral deviation of the wheels by virtue of an opposite force. In addition, when the lower trolley deviates from the outer-side tracks, the horizontal wheel rotates on sides of the outer-side tracks around the rotation shaft, so that friction can be reduced, and the abrasion of the outer-side tracks can be reduced.

For the aforementioned novel lower-trolley system, the horizontal wheel has a shape of an inverted horn.

Compared with the prior art, the present disclosure has the benefits.

1. The novel lower-trolley system is used for upgrading the conventional quay crane, outer sides of two original box beams are each additionally provided with two plates to form the double-trapezoid four-track girder, and the outer side of the double-trapezoid four-track girder is additionally provided with track bearing beams and is laid with the outer-side tracks to bear the newly added lower trolley which is suspended upside down. The two trolleys pass by each other to flexibly operate, and it is possible that one of the trolleys operates or the two trolleys operate at the same time.

2. Due to the arrangement of the floating coupling, it can be ensured that the lower-trolley hoisting mechanism part-A and the lower-trolley hoisting mechanism part-B operate synchronously, and the problem that the hoist of the lower trolley tilts due to operation asynchronism of the two mechanisms is avoided, which is a great innovation for the lower-trolley hoisting mechanism. In addition, the quay crane machine room is limited in space, in order to place the newly added lower-trolley hoisting mechanism part-A and lower-trolley hoisting mechanism part-B without newly building a machine room or reducing the upgrading cost, the floating coupling plays a good linking role, and the floating coupling is set to be small-sized and is respectively connected with the lower-trolley hoisting mechanism part-A and the lower-trolley hoisting mechanism part-B on the left and the right, so that the remaining space of the original quay crane machine room is sufficiently utilized, the utility rate of the space is increased, and the stable operation of the newly added lower trolley can also be guaranteed.

3. The two trolleys are vertically disposed, wherein the lower trolley is provided with the recessed frame which forms a recessed self-closed space in space, and such a space is large enough to allow the container hoisted by the upper trolley to pass by without interference. Compared with a U-shaped frame of a lower trolley of a novel quay crane, the present structure allows the upper trolley and the lower trolley to pass by each other without changing a girder spacing of the conventional quay crane on the premise that the upgrading cost is relatively low, and interference can also be avoided. The space structure for the lower trolley is cleverly arranged, such that the upper trolley and the lower trolley of the upgraded quay crane have enough space to pass by each other, and the quay crane is upgraded from one trolley to two trolleys to operate, so that the efficiency of the upgraded quay crane is increased by more than 1.5 times as comparison with that of the conventional quay crane having the single trolley. The level equivalent to the loading and unloading efficiency of two quay cranes can be achieved with relatively low upgrading investment, so that the port investment is reduced.

4. According to the present disclosure, due to the special structural design for the lower-trolley hoisting mechanism and the lower-trolley hoisting winding system, the lower-trolley hoisting mechanism and the lower-trolley hoisting winding system are effectively staggered from the upper-trolley hoisting mechanism and the upper-trolley hoisting winding system without interfering with each other. The horizontal guide wheel group can prevent the wheels of the lower trolley from deviating and also reduce the abrasion of the outer-side tracks. Specifically, when the lower trolley laterally deviates, the horizontal guide wheel group may abut against the outer sides of the wheels to correct the lateral deviation of the wheels by virtue of an opposite force. In addition, when the lower trolley deviates from the outer-side tracks, the horizontal wheel rotates on sides of the outer-side tracks around the rotation shaft, so that friction can be reduced, and the abrasion of the outer-side tracks can be reduced.

5. The movable trolley is used for bearing the hoist and is capable of moving on the recessed frame.

### BRIEF DESCRIPTION OF THE DRAWINGS

FIG. 1 is a structural schematic diagram of an upgraded quay crane in accordance with the present disclosure;

FIG. 2 is a front structural schematic diagram of a lower trolley in accordance with the present disclosure;

FIG. 3 is a side structural schematic diagram of a lower trolley in accordance with the present disclosure;

FIG. 4 is a structural schematic diagram of a lower-trolley hoisting winding system in accordance with the present disclosure;

FIG. 5 is a layout structure diagram of a quay crane machine room in accordance with the present disclosure;

FIG. 6 is a structural schematic diagram of a movable trolley in accordance with the present disclosure; and

FIG. 7 is a structural schematic diagram of a horizontal guide wheel group in accordance with the present disclosure.

Meanings of reference numerals in the accompanying drawings: 1—double-trapezoid four-track girder, 2—upper trolley, 3—lower trolley, 4—horizontal frame, 5—recessed frame, 6—movable trolley, 7—horizontal guide wheel group, 8—first vertical frame group, 9—second vertical frame group, 10—trolley body, 12—container, 13—wheel, 14—hoist, 15—outer-side track, 16—inner-side track, 17—travelling wheel, 18—horizontal wheel, 19—first vertical rod, 20—second vertical rod, 21—rotation shaft, 24—quay crane machine room, 27—lower-trolley hoisting mechanism, 29—lower-trolley hoisting mechanism part-A, 30—lower-trolley hoisting mechanism part-B, 31—floating coupling, 32—upper-trolley hoisting mechanism, 33—lower-trolley hoisting winding group-A, 34—lower-trolley hoisting winding group-B, 35—hoist rope, 36—first quay crane redirecting pulley block, 37—second quay crane redirecting pulley block, 38—quay crane pulley-A, 39—quay crane pulley-B, 40—hoist pulley-A, 41—hoist pulley-B, 101—first redirecting pulley block, 102—second redirecting pulley block, 103—third redirecting pulley block, 104—fourth redirecting pulley block, 105—fifth redirecting pulley block, 106—sixth redirecting pulley block, 107—seventh redirecting pulley block, and 108—eighth redirecting pulley block.

The present disclosure will be further described below with reference to the accompanying drawings and specific implementations.

### DETAILED DESCRIPTION OF THE EMBODIMENTS

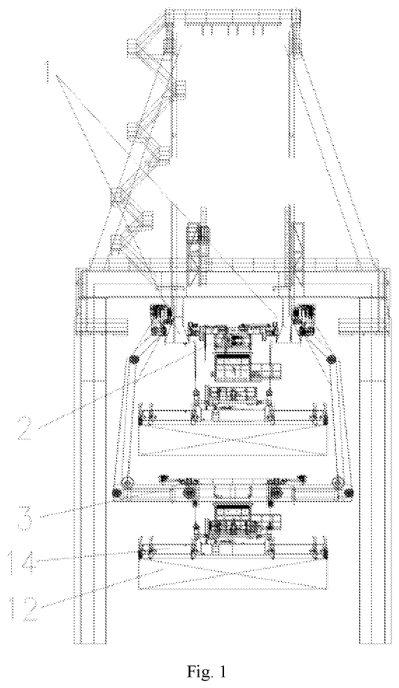

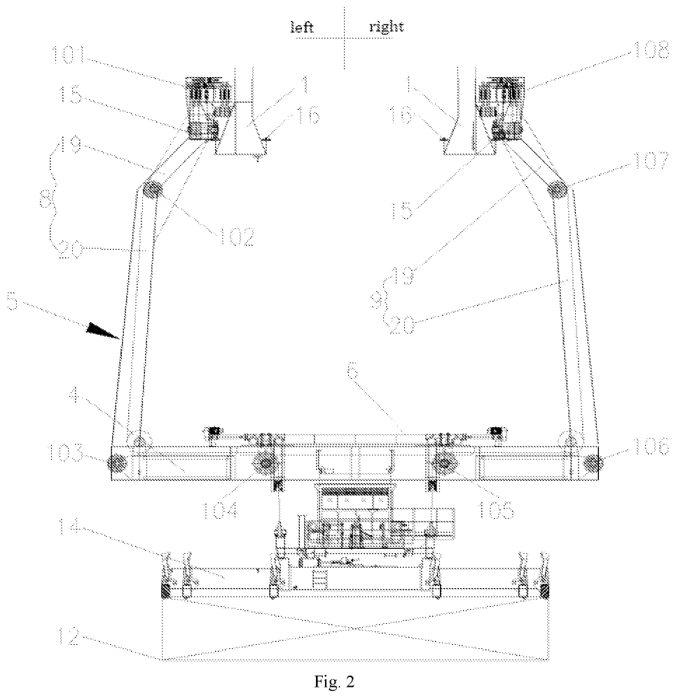

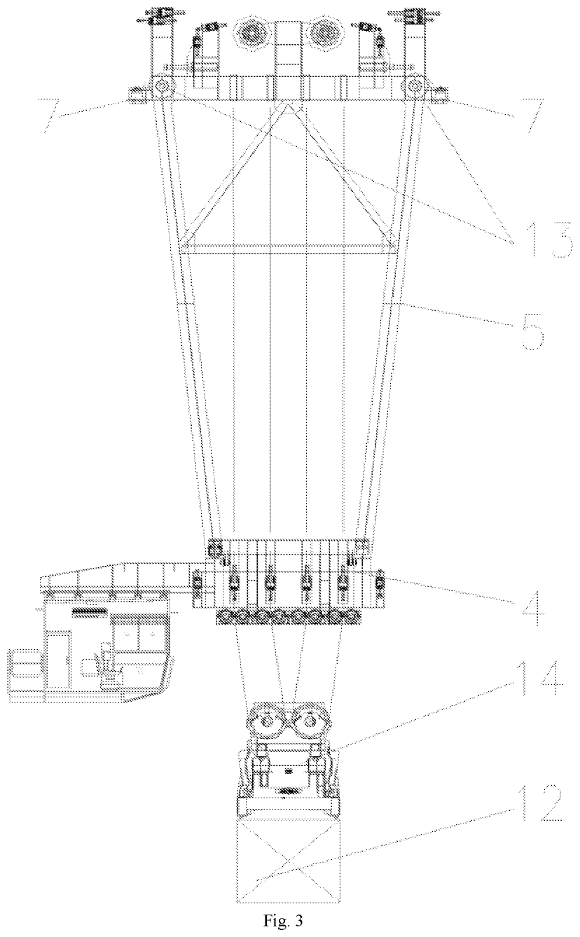

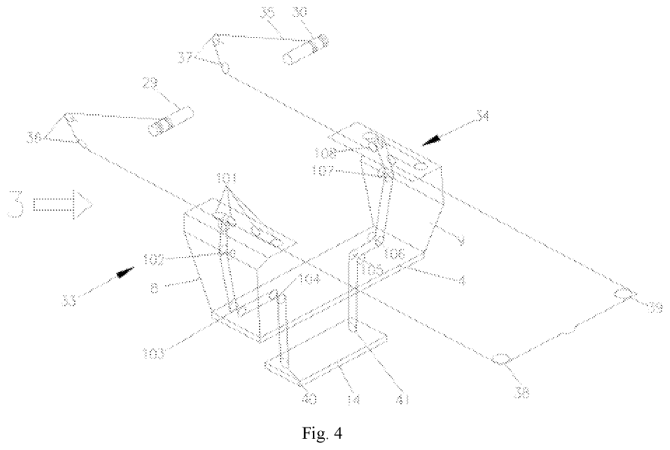

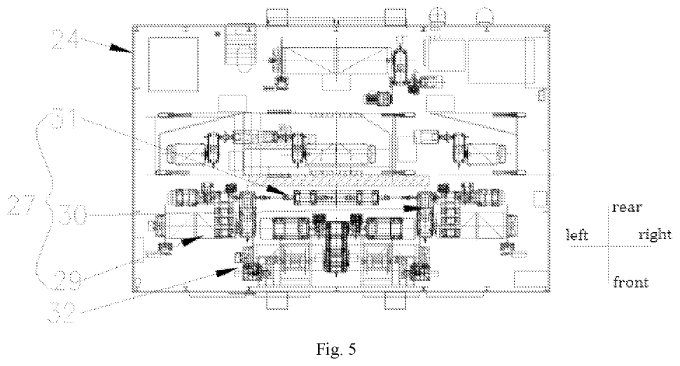

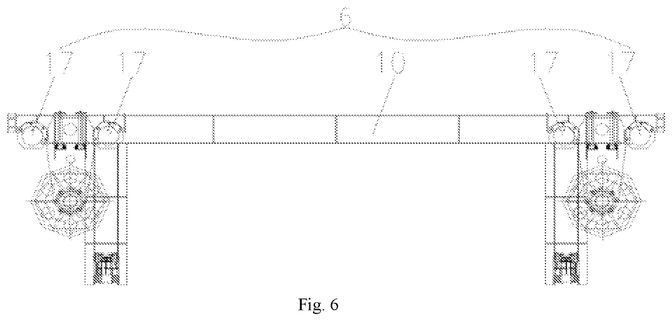

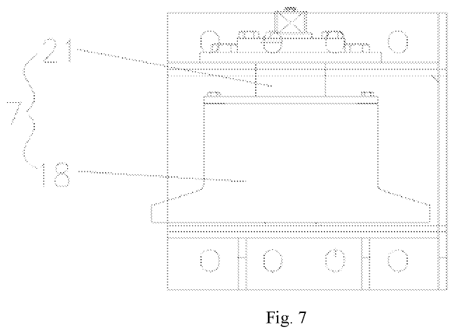

Embodiment 1 of the present disclosure: as shown in FIG. 1 to FIG. 7, provided is a novel lower-trolley system in which a conventional quay crane girder is upgraded into a double-trapezoid four-track girder 1, and inner-side tracks 16 of the double-trapezoid four-track girder 1 are configured for an upper trolley 2 to travel on. The novel lower-trolley system includes a lower trolley 3, a lower-trolley hoisting system, and a lower-trolley travelling system, and the lower trolley 3, the lower-trolley hoisting system and the lower-trolley travelling system are all arranged on a quay crane; the lower-trolley hoisting system is configured to drive a hoist 14 of the lower trolley 3 to rise and fall, and the lower-trolley travelling system is configured to pull the lower trolley 3 to travel along the direction of the double-trapezoid four-track girder 1 of the quay crane; and the lower trolley 3 is suspended upside down on outer-side tracks 15 of the double-trapezoid four-track girder 1, and a container 12 hoisted by the upper trolley 2 is able to pass through the lower trolley 3. The novel lower-trolley system is used for upgrading a conventional quay crane, outer sides of two original box beams are each additionally provided with two plates to form the double-trapezoid four-track girder 1, and the outer side of the double-trapezoid four-track girder 1 is additionally provided with track bearing beams and is laid with the outer-side tracks 15 to bear the newly added lower trolley 3 which is suspended upside down. Specifically, the novel lower-trolley system is designed, so that the hoist 14 of the lower trolley 3 is able to rise and fall, and the lower trolley 3 is able to travel. The space structure for the lower trolley is cleverly arranged, such that the upper trolley 2 and the lower trolley 3 of the upgraded quay crane have enough space to pass by each other without interfering with each other, and the quay crane is upgraded from one trolley to two trolleys to operate, so that the operation efficiency of the quay crane is greatly increased.

Embodiment 2: as shown in FIG. 1 to FIG. 7, provided is a novel lower-trolley system in which a conventional quay crane girder is upgraded into a double-trapezoid four-track girder 1, and inner-side tracks 16 of the double-trapezoid four-track girder 1 are configured for an upper trolley 2 to travel on. The novel lower-trolley system includes a lower trolley 3, a lower-trolley hoisting system, and a lower-trolley travelling system, and the lower trolley 3, the lower-trolley hoisting system and the lower-trolley travelling system are all arranged on a quay crane; the lower-trolley hoisting system is configured to drive a hoist 14 of the lower trolley 3 to rise and fall, and the lower-trolley travelling system is configured to pull the lower trolley 3 to travel along the direction of the double-trapezoid four-track girder 1 of the quay crane; and the lower trolley 3 is suspended upside down on outer-side tracks 15 of the double-trapezoid four-track girder 1, and a container 12 hoisted by the upper trolley 2 is able to pass through the lower trolley 3. The novel lower-trolley system is used for upgrading a conventional quay crane, outer sides of two original box beams are each additionally provided with two plates to form the double-trapezoid four-track girder 1, and the outer side of the double-trapezoid four-track girder 1 is additionally provided with track bearing beams and is laid with the outer-side tracks 15 to bear the newly added lower trolley 3 which is suspended upside down. Specifically, the novel lower-trolley system is designed, so that the hoist 14 of the lower trolley 3 is able to rise and fall, and the lower trolley 3 is able to travel. The space structure for the lower trolley is cleverly arranged, such that the upper trolley 2 and the lower trolley 3 of the upgraded quay crane have enough space to pass by each other without interfering with each other, and the quay crane is upgraded from one trolley to two trolleys to operate, so that the operation efficiency of the quay crane is greatly increased.

Further, the lower-trolley hoisting system includes a lower-trolley hoisting mechanism 27 and a lower-trolley hoisting winding system, and the lower-trolley hoisting mechanism 27 is configured to drive the hoist 14 of the lower trolley 3 to rise and fall through the lower-trolley hoisting winding system. The lower-trolley hoisting mechanism 27 is arranged in a quay crane machine room 24, the lower-trolley hoisting mechanism 27 includes a lower-trolley hoisting mechanism part-A 29, a lower-trolley hoisting mechanism part-B 30 and a floating coupling 31, the lower-trolley hoisting mechanism part-A 29 is connected to the lower-trolley hoisting mechanism part-B 30 via the floating coupling 31, wherein the floating coupling 31 is horizontally arranged behind an upper-trolley hoisting mechanism 32, and the lower-trolley hoisting mechanism part-A 29 and the lower-trolley hoisting mechanism part-B 30 are respectively arranged on left and right sides of the upper-trolley hoisting mechanism 32. The lower-trolley hoisting winding system includes a lower-trolley hoisting winding group-A 33 and a lower-trolley hoisting winding group-B 34, the lower-trolley hoisting mechanism part-A 29 is configured to drive the hoist 14 of the lower trolley 3 to rise and fall through the lower-trolley hoisting winding group-A 33, and meanwhile, the lower-trolley hoisting mechanism part-B 30 is configured to drive the hoist 14 of the lower trolley 3 to rise and fall through the lower-trolley hoisting winding group-B 34. Due to the arrangement of the floating coupling 31, it can be ensured that the lower-trolley hoisting mechanism part-A 29 and the lower-trolley hoisting mechanism part-B 30 operate synchronously, and the problem that the hoist 14 of the lower trolley tilts due to operation asynchronism of the two mechanisms is avoided, which is a great innovation for the lower-trolley hoisting mechanism 27. In addition, the quay crane machine room 24 is limited in space, in order to place the newly added lower-trolley hoisting mechanism part-A 29 and lower-trolley hoisting mechanism part-B 30 without newly building a machine room or reducing the upgrading cost, the floating coupling 31 plays a good linking role, and the floating coupling 31 is set to be small-sized and is respectively connected with the lower-trolley hoisting mechanism part-A 29 and the lower-trolley hoisting mechanism part-B 30 on the left and the right, so that the remaining space of the original quay crane machine room 24 is sufficiently utilized, the utility rate of the space is increased, and the stable operation of the newly added lower trolley can also be guaranteed. Specifically, the lower-trolley hoisting mechanism part-A 29 includes a hoist drum-A, a motor-A, and a speed reducer-A, wherein one side of the motor-A is coaxially connected with the speed reducer-A, and the other side of the motor-A is connected with the hoist drum-A by a shaft; and the lower-trolley hoisting mechanism part-B 30 includes a hoist drum-B, a motor-B, and a speed reducer-B, wherein one side of the motor-B is coaxially connected with the speed reducer-B, and the other side of the motor-B is connected with the hoist drum-B by a shaft.

Further, the lower trolley 3 includes a recessed frame 5, a movable trolley 6 and wheels 13, wherein the wheels 13 are arranged on two sides of the top of the recessed frame 5 and are configured to roll on the outer-side tracks 15 of the double-trapezoid four-track girder 1, the movable trolley 6 is arranged on the bottom of the recessed frame 5, and the hoist 14 is connected below the movable trolley 6. The lower trolley is provided with the recessed frame 5 which forms a recessed self-closed space in space, and such a space is large enough to allow the container 12 hoisted by the upper trolley 2 to pass by without interference. Compared with a U-shaped frame of a lower trolley of a novel quay crane, the present structure allows the upper trolley 2 to pass through the recessed space of the lower trolley 3 without changing the position of the double-trapezoid four-track girder 1, thereby reducing the investment. The movable trolley 6 is used for bearing the hoist 14 and is capable of moving on the recessed frame 5. A movable trolley track is laid on the bottom of the recessed frame 5, the movable trolley 6 includes a trolley body 10 and travelling wheels 17, and the travelling wheels 17 are mounted on two sides of the bottom of the trolley body 10 and are configured to roll on the movable trolley track.

Specifically, the recessed frame 5 includes a horizontal frame 4, a first vertical frame group 8, and a second vertical frame group 9, wherein one end of the horizontal frame 4 is connected with an end of the first vertical frame group 8, the other end of the horizontal frame 4 is connected with an end of the second vertical frame group 9, and structures of the first vertical frame group 8 and the second vertical frame group 9 are symmetrically disposed relative to the middle of the horizontal frame 4. The first vertical frame group 8 includes a first vertical rod 19 and a second vertical rod 20; the second vertical frame group 9 further includes a first vertical rod 19 and a second vertical rod 20; and the wheels 13 are arranged on top ends of the first vertical rods 19, the other ends of the first vertical rods 19 are connected with ends of the second vertical rods 20, and the other ends, away from the first vertical rods 19, of the second vertical rods 20 are connected with the horizontal frame 4. An included angle between each of the first vertical rods 19 and a vertical central line of a corresponding one of the outer-side tracks 15 is an acute angle, an included angle between each of the first vertical rods 19 and a corresponding one of the second vertical rods 20 is a blunt angle, and an included angle between each of the second vertical rods 20 and the horizontal frame 4 is an acute angle or a right angle. In such a layout way, the bearing capacity of the recessed frame 5 can be better achieved, and the stability in an operation process is higher. In such a layout way, the upper trolley 2 and the lower trolley 3 can pass by each other without changing a girder spacing of the conventional quay crane on the premise that the upgrading cost is relatively low, and interference can also be avoided.

Further, the novel lower-trolley system further includes a first redirecting pulley block 101, a second redirecting pulley block 102, a third redirecting pulley block 103, a fourth redirecting pulley block 104, a fifth redirecting pulley block 105, a sixth redirecting pulley block 106, a seventh redirecting pulley block 107, and an eighth redirecting pulley block 108, wherein the first redirecting pulley block 101 is mounted on the top of the first vertical rod 19 of the first vertical frame group 8, the second redirecting pulley block 102 is mounted on an intersection of the first vertical rod 19 of the first vertical frame group 8 and the second vertical rod 20 of the first vertical frame group 8, the horizontal frame 4 is sequentially provided with the third redirecting pulley block 103, the fourth redirecting pulley block 104, the fifth redirecting pulley block 105, and the sixth redirecting pulley block 106 from left to right, the seventh redirecting pulley block 107 is mounted on an intersection of the first vertical rod 19 of the second vertical frame group 9 and the second vertical rod 20 of the second vertical frame group 9, and the eighth redirecting pulley block 108 is mounted on the top of the first vertical rod 19 of the second vertical frame group 9.

Specifically, the lower-trolley hoisting winding group-A 33 includes a first quay crane redirecting pulley block 36 mounted on the quay crane, further includes the first redirecting pulley block 101, the second redirecting pulley block 102, the third redirecting pulley block 103, and the fourth redirecting pulley block 104, further includes a hoist pulley-A 40 mounted on the hoist 14 of the lower trolley 3, and further includes a quay crane pulley-A 38 mounted on the double-trapezoid four-track girder 1 of the quay crane. The lower-trolley hoisting winding group-B 34 includes a hoist rope 35, further includes a second quay crane redirecting pulley block 37 mounted on the quay crane, further includes the fifth redirecting pulley block 105, the sixth redirecting pulley block 106, the seventh redirecting pulley block 107, and the eighth redirecting pulley block 108, further includes a hoist pulley-B 41 mounted on the hoist 14 of the lower trolley 3, and further includes a quay crane pulley-B 39 mounted on the double-trapezoid four-track girder 1 of the quay crane. One end of the hoist rope 35 is wound on the lower-trolley hoisting mechanism part-B 30, and the other end of the hoist rope 35, after firstly being wound through a lower side of the second quay crane redirecting pulley block 37 and then being wound through the eighth redirecting pulley block 108, the seventh redirecting pulley block 107, the sixth redirecting pulley block 106, the fifth redirecting pulley block 105, and the hoist pulley-B 41, is wound on the quay crane pulley-B 39, and, after being wound through the quay crane pulley-A 38 and then being wound through the first redirecting pulley block 101, the second redirecting pulley block 102, the third redirecting pulley block 103, the fourth redirecting pulley block 104, and the hoist pulley-A 40, is wound on the first quay crane redirecting pulley block 36, and is finally wound on the lower-trolley hoisting mechanism part-A 29. According to the present disclosure, due to the special structural design for the lower-trolley hoisting mechanism 27 and the lower-trolley hoisting winding system, the lower-trolley hoisting mechanism 27 and the lower-trolley hoisting winding system are effectively staggered from the upper-trolley hoisting mechanism 32 and the upper-trolley hoisting winding system without interfering with each other.

Further, horizontal guide wheel groups 7 are further mounted on the top of the recessed frame 5 and are arranged on outer sides of the wheels 13; and each of the horizontal guide wheel groups 7 includes a horizontal wheel 18 and a rotation shaft 21, and the horizontal wheel 18 is coaxially sleeved on the rotation shaft 21 and is able to rotate around the rotation shaft 21. The horizontal wheel 18 has a shape of an inverted horn. The horizontal guide wheel group 7 is able to prevent the wheels 13 of the lower trolley 3 from deviating and also reduce the abrasion of the outer-side tracks 15. Specifically, when the lower trolley 3 laterally deviates, the horizontal guide wheel group 7 may abut against the outer sides of the wheels 13 to correct the lateral deviation of the wheels 13 by virtue of an opposite force. In addition, when the lower trolley 3 deviates from the outer-side tracks 15, the horizontal wheel 18 rotates on sides of the outer-side tracks 15 around the rotation shaft 21, so that friction can be reduced, and the abrasion of the outer-side tracks 15 can be reduced.

The working principle of the novel lower-trolley system is that the novel lower-trolley system may be used for upgrading the conventional quay crane having the single trolley to increase the loading and unloading efficiency of the present quay crane without newly building a quay crane. Specifically, a lower trolley 3 which is recessed is suspended upside down on outer-side tracks of a double-trapezoid four-track girder 1 of an upgraded novel quay crane and is effectively staggered from an upper trolley 2 arranged on an inner side of a conventional quay crane girder, and the upper trolley 2 and the lower trolley 3 can pass by each other without interfering with each other. The novel lower-trolley system includes a lower trolley 3, a lower-trolley hoisting system, and a lower-trolley travelling system, and the lower trolley 3, the lower-trolley hoisting system and the lower-trolley travelling system are all arranged on a quay crane; the lower-trolley hoisting system is configured to drive a hoist 14 of the lower trolley 3 to rise and fall; and the lower-trolley travelling system is configured to pull the lower trolley 3 to travel along the direction of the double-trapezoid four-track girder 1 of the quay crane. The lower-trolley hoisting system includes a lower-trolley hoisting mechanism 27 and a lower-trolley hoisting winding system, and the lower-trolley hoisting mechanism 27 is configured to drive the hoist 14 of the lower trolley 3 to rise and fall through the lower-trolley hoisting winding system. The lower-trolley hoisting mechanism 27 includes a lower-trolley hoisting mechanism part-A 29, a lower-trolley hoisting mechanism part-B 30 and a floating coupling 31, and the lower-trolley hoisting mechanism part-A 29 is connected to the lower-trolley hoisting mechanism part-B 30 via the floating coupling 31, so that it is ensured that the lower-trolley hoisting mechanism part-A 29 and the lower-trolley hoisting mechanism part-B 30 operate synchronously. The lower trolley 3 is composed of a recessed frame 5, a movable trolley 6 and the like, wherein the recessed frame 5 forms a recessed self-closed space in space, and such a space is large enough to allow the container 12 hoisted by the upper trolley 2 to pass by without interference in conventional quay crane upgrading. Compared with a U-shaped frame, the present structure allows the upper trolley 2 to pass through the recessed space of the lower trolley 3 without changing the position of the girder, thereby reducing the investment. The movable trolley 6 is located on the bottom of the recessed frame 5 and is used for horizontal fine adjustment of the hoist 14. The lower trolley 3 capable of moving along the outer-side tracks 15 of the double-trapezoid four-track girder 1 and the upper trolley 2 moving on inner-side tracks 16 of the double-trapezoid four-track girder 1 have enough space to pass by each other without interfering with each other, thereby increasing the hoisting efficiency of the container 12.

What is claimed is:

1. A novel lower-trolley system, in which a conventional quay crane girder is upgraded into a double-trapezoid four-track girder (1), and inner-side tracks (16) of the double-trapezoid four-track girder (1) are configured for an upper trolley (2) to travel on, wherein the novel lower-trolley system comprises a lower trolley (3), a lower-trolley hoisting system, and a lower-trolley travelling system, and the lower trolley (3), the lower-trolley hoisting system and the lower-trolley travelling system are all arranged on a quay crane; the lower-trolley hoisting system is configured to drive a hoist (14) of the lower trolley (3) to rise and fall, and the lower-trolley travelling system is configured to pull the lower trolley (3) to travel along the direction of the double-trapezoid four-track girder (1) of the quay crane; and the lower trolley (3) is suspended upside down on outer-side tracks (15) of the double-trapezoid four-track girder (1), and a container (12) hoisted by the upper trolley (2) is able to pass through the lower trolley (3);
wherein the lower-trolley hoisting system comprises a lower-trolley hoisting mechanism (27), the lower-trolley hoisting mechanism (27) comprises a lower-trolley hoisting mechanism part-A (29), a lower-trolley hoisting mechanism part-B (30) and a floating coupling (31), the lower-trolley hoisting mechanism part-A (29) is connected to the lower-trolley hoisting mechanism part-B (30) via the floating coupling (31).

2. The novel lower-trolley system of claim 1, wherein the lower-trolley hoisting system further comprises a lower-trolley hoisting winding system, and the lower-trolley hoisting mechanism (27) is configured to drive the hoist (14) of the lower trolley (3) to rise and fall through the lower-trolley hoisting winding system;
the lower-trolley hoisting mechanism (27) is arranged in a quay crane machine room (24), wherein the floating coupling (31) is horizontally arranged behind an upper-trolley hoisting mechanism (32), and the lower-trolley hoisting mechanism part-A (29) and the lower-trolley hoisting mechanism part-B (30) are respectively arranged on left and right sides of the upper-trolley hoisting mechanism (32); and
the lower-trolley hoisting winding system comprises a lower-trolley hoisting winding group-A (33) and a lower-trolley hoisting winding group-B (34), the lower-trolley hoisting mechanism part-A (29) is configured to drive the hoist (14) of the lower trolley (3) to rise and fall through the lower-trolley hoisting winding group-A (33), and meanwhile, the lower-trolley hoisting mechanism part-B (30) is configured to drive the hoist (14) of the lower trolley (3) to rise and fall through the lower-trolley hoisting winding group-B (34).

3. The novel lower-trolley system of claim 2, wherein the lower trolley (3) comprises a recessed frame (5), a movable trolley (6) and wheels (13), wherein the wheels (13) are arranged on two sides of the top of the recessed frame (5) and are configured to roll on the outer-side tracks (15) of the double-trapezoid four-track girder (1), the movable trolley (6) is arranged on the bottom of the recessed frame (5), and the hoist (14) is connected below the movable trolley (6).

4. The novel lower-trolley system of claim 3, wherein a movable trolley track is laid on the bottom of the recessed frame (5), the movable trolley (6) comprises a trolley body (10) and travelling wheels (17), and the travelling wheels (17) are mounted on two sides of the bottom of the trolley body (10) and are configured to roll on the movable trolley track.

5. The novel lower-trolley system of claim 4, wherein the recessed frame (5) comprises a horizontal frame (4), a first vertical frame group (8), and a second vertical frame group (9), wherein one end of the horizontal frame (4) is connected with an end of the first vertical frame group (8), the other end of the horizontal frame (4) is connected with an end of the second vertical frame group (9), and structures of the first vertical frame group (8) and the second vertical frame group (9) are symmetrically disposed relative to the middle of the horizontal frame (4); the first vertical frame group (8) comprises a first vertical rod (19) and a second vertical rod (20); the second vertical frame group (9) further comprises a first vertical rod (19) and a second vertical rod (20); and the wheels (13) are arranged on top ends of the first vertical rods (19), the other ends of the first vertical rods (19) are connected with ends of the second vertical rods (20), and the other ends, away from the first vertical rods (19), of the second vertical rods (20) are connected with the horizontal frame (4).

6. The novel lower-trolley system of claim 5, further comprising a first redirecting pulley block (101), a second redirecting pulley block (102), a third redirecting pulley block (103), a fourth redirecting pulley block (104), a fifth redirecting pulley block (105), a sixth redirecting pulley block (106), a seventh redirecting pulley block (107), and an eighth redirecting pulley block (108), wherein the first redirecting pulley block (101) is mounted on the top of the first vertical rod (19) of the first vertical frame group (8), the second redirecting pulley block (102) is mounted on an intersection of the first vertical rod (19) of the first vertical frame group (8) and the second vertical rod (20) of the first vertical frame group (8), the horizontal frame (4) is sequentially provided with the third redirecting pulley block (103), the fourth redirecting pulley block (104), the fifth redirecting pulley block (105), and the sixth redirecting pulley block (106) from left to right, the seventh redirecting pulley block (107) is mounted on an intersection of the first vertical rod (19) of the second vertical frame group (9) and the second vertical rod (20) of the second vertical frame group (9), and the eighth redirecting pulley block (108) is mounted on the top of the first vertical rod (19) of the second vertical frame group (9).

7. The novel lower-trolley system of claim 6, wherein the lower-trolley hoisting winding group-A (33) comprises a first quay crane redirecting pulley block (36) mounted on the quay crane, further comprises the first redirecting pulley block (101), the second redirecting pulley block (102), the third redirecting pulley block (103), and the fourth redirecting pulley block (104), further comprises a hoist pulley-A (40) mounted on the hoist (14) of the lower trolley (3), and further comprises a quay crane pulley-A (38) mounted on the double-trapezoid four-track girder (1) of the quay crane;
the lower-trolley hoisting winding group-B (34) comprises a hoist rope (35), further comprises a second quay crane redirecting pulley block (37) mounted on the quay crane, further comprises the fifth redirecting pulley block (105), the sixth redirecting pulley block (106), the seventh redirecting pulley block (107), and the eighth redirecting pulley block (108), further comprises a hoist pulley-B (41) mounted on the hoist (14) of the lower trolley (3), and further comprises a quay crane pulley-B (39) mounted on the double-trapezoid four-track girder (1) of the quay crane; and
one end of the hoist rope (35) is wound on the lower-trolley hoisting mechanism part-B (30), and the other end of the hoist rope (35), after firstly being wound through a lower side of the second quay crane redirecting pulley block (37) and then being wound through the eighth redirecting pulley block (108), the seventh redirecting pulley block (107), the sixth redirecting pulley block (106), the fifth redirecting pulley block (105), and the hoist pulley-B (41), is wound on the quay crane pulley-B (39), and, after being wound through the quay crane pulley-A (38) and then being wound through the first redirecting pulley block (101), the second redirecting pulley block (102), the third redirecting pulley block (103), the fourth redirecting pulley block (104), and the hoist pulley-A (40), is wound on the first quay crane redirecting pulley block (36), and is finally wound on the lower-trolley hoisting mechanism part-A (29).

8. The novel lower-trolley system of claim 7, wherein an included angle between each of the first vertical rods (19) and a vertical central line of a corresponding one of the outer-side tracks (15) is an acute angle, an included angle between each of the first vertical rods (19) and a corresponding one of the second vertical rods (20) is a blunt angle, and an included angle between each of the second vertical rods (20) and the horizontal frame (4) is an acute angle or a right angle.

9. The novel lower-trolley system of claim 8, wherein horizontal guide wheel groups (7) are further mounted on the top of the recessed frame (5) and are arranged on outer sides of the wheels (13); and each of the horizontal guide wheel groups (7) comprises a horizontal wheel (18) and a rotation shaft (21), and the horizontal wheel (18) is coaxially sleeved on the rotation shaft (21) and is able to rotate around the rotation shaft (21).

10. The novel lower-trolley system of claim 9, wherein the horizontal wheel (18) has a shape of an inverted horn.
